(19) United States
(12) Patent Application Publication
(10) Pub. No.: US 2022/0237926 A1
(43) Pub. Date: Jul. 28, 2022

(54) TRAVEL MANAGEMENT DEVICE, TRAVEL MANAGEMENT METHOD, AND RECORDING MEDIUM

(71) Applicant: NEC Corporation, Minato-ku, Tokyo (JP)

(72) Inventors: Nana JUMONJI, Tokyo (JP); Toshihiro WATANABE, Tokyo (JP)

(73) Assignee: NEC Corporation, Minato-ku, Tokyo (JP)

(21) Appl. No.: 17/617,094

(22) PCT Filed: Jun. 10, 2020
(86) PCT No.: PCT/JP2020/022876

§ 371 Date: Dec. 7, 2021

(30) Foreign Application Priority Data
Jun. 10, 2019 (JP) 2019-108134

(51) Int. Cl. G06V 20/58; G08G 1/056

(52) U.S. Cl. CPC G06V 20/582; G08G 1/056

(57) ABSTRACT

A travel management device detects that a moving body is traveling in a wrong direction on a travel path on which the moving body is currently traveling, based on at least one of a front recognition result and a rear recognition result, the front recognition result indicating display content displayed by a sign appearing in a front captured image, the front captured image being obtained by capturing an image to front of the moving body, the rear recognition result indicating display content displayed by a sign appearing in a rear captured image, the rear captured image being obtained by capturing an image to rear of the moving body. Furthermore, the travel management device detects a possibility of the moving body traveling in a wrong direction in future on a travel path located ahead in a travel direction of the moving body than the travel path on which the moving body is currently traveling, based on at least one of the front recognition result and the rear recognition result.

### TECHNICAL FIELD

The present invention relates to a travel management device, a travel management method, and a recording medium.

### BACKGROUND ART

The phenomenon in which a moving body such as an automobile travels in the direction opposite to the forward travel direction permitted on a travel path (travels the wrong way), whereby an accident such as a collision occurs with another moving body, has become a problem. Patent Document 1 discloses a technique of recognizing a road sign from an image captured in front of and/or behind a vehicle and determining whether or not the vehicle is traveling in the wrong direction.

### PRIOR ART DOCUMENTS

### Non-Patent Documents

[Patent Document 1] PCT International Publication WO No. 2015/098915

### SUMMARY OF THE INVENTION

### Problem to be Solved by the Invention

It is desirable to be able to detect whether or not a moving body is traveling in the wrong direction not only when traveling of the moving body in the wrong direction has occurred but also as much as possible before the moving body is in the state of traveling in the wrong direction.

An example object of the present invention is to provide a travel management device, a travel management method, and a recording medium that solve the above-mentioned problem.

### Means for Solving the Problem

In a first example aspect of the present disclosure, a travel management device includes: a detection means for detecting that a moving body is traveling in a wrong direction on a travel path on which the moving body is currently traveling, based on at least one of a front recognition result and a rear recognition result, the front recognition result indicating display content displayed by a sign appearing in a front captured image, the front captured image being obtained by capturing an image to front of the moving body, the rear recognition result indicating display content displayed by a sign appearing in a rear captured image, the rear captured image being obtained by capturing an image to rear of the moving body; and a prevention means for detecting a possibility of the moving body traveling in a wrong direction in future on a travel path located ahead in a travel direction of the moving body than the travel path on which the moving body is currently traveling, based on at least one of the front recognition result and the rear recognition result.

In a second example aspect of the present disclosure, a travel management method includes: detecting that a moving body is traveling in a wrong direction on a travel path on which the moving body is currently traveling, based on at least one of a front recognition result and a rear recognition result, the front recognition result indicating display content displayed by a sign appearing in a front captured image, the front captured image being obtained by capturing an image to front of the moving body, the rear recognition result indicating display content displayed by a sign appearing in a rear captured image, the rear captured image being obtained by capturing an image to rear of the moving body; and detecting a possibility of the moving body traveling in a wrong direction in future on a travel path located ahead in a travel direction of the moving body than the travel path on which the moving body is currently traveling, based on at least one of the front recognition result and the rear recognition result.

In a third example aspect of the present disclosure, a recording medium stores a program for causing a computer of a travel management device to execute: detecting that a moving body is traveling in a wrong direction on a travel path on which the moving body is currently traveling, based on at least one of a front recognition result and a rear recognition result, the front recognition result indicating display content displayed by a sign appearing in a front captured image, the front captured image being obtained by capturing an image to front of the moving body, the rear recognition result indicating display content displayed by a sign appearing in a rear captured image, the rear captured image being obtained by capturing an image to rear of the moving body; and detecting a possibility of the moving body traveling in a wrong direction in future on a travel path located ahead in a travel direction of the moving body than the travel path on which the moving body is currently traveling, based on at least one of the front recognition result and the rear recognition result.

### Effect of the Invention

According to an example embodiment of the present invention, it is possible to detect the possibility that a moving body travels in the wrong direction before the moving body is in a state of traveling in the wrong direction.

### BRIEF DESCRIPTION OF THE DRAWINGS

FIG. 1 is a diagram showing a travel management system according to the present example embodiment.

FIG. 2 is a hardware configuration diagram of the travel management device according to the present example embodiment.

FIG. 3 is a hardware configuration diagram of the travel management device according to the present example embodiment.

FIG. 4 is a diagram showing a hardware configuration of a drive recorder according to the present example embodiment.

FIG. 5 is a function block diagram of a control device provided in the drive recorder according to the present example embodiment.

FIG. 6 is a first diagram showing an outline of processing of the travel management device according to the present example embodiment.

FIG. 7 is a second diagram showing an outline of processing of the travel management device according to the present example embodiment.

FIG. 8 is a third diagram showing an outline of processing of the travel management device according to the present example embodiment.

FIG. 9 is a fourth diagram showing an outline of processing of the travel management device according to the present example embodiment.

FIG. 10 is a first diagram showing the flow of processing of the drive recorder according to the present example embodiment.

FIG. 11 is a first diagram showing the flow of processing of the travel management device according to the present example embodiment.

FIG. 12 is a second diagram showing the flow of processing of the travel management device according to the present example embodiment.

FIG. 13 is a third diagram showing the flow of processing of the travel management device according to the present example embodiment.

FIG. 14 is a fourth diagram showing the flow of processing of the travel management device according to the present example embodiment.

FIG. 15 is a second diagram showing the flow of processing of the drive recorder according to the present example embodiment.

FIG. 16 is a fourth diagram showing the flow of processing of the travel management device according to the present example embodiment.

FIG. 17 is a diagram showing an example of the configuration of the travel management device according to the present example embodiment.

### EXAMPLE EMBODIMENTS

Hereinbelow, a travel management system including a travel management device according to an example embodiment of the present invention will be described with reference to the drawings.

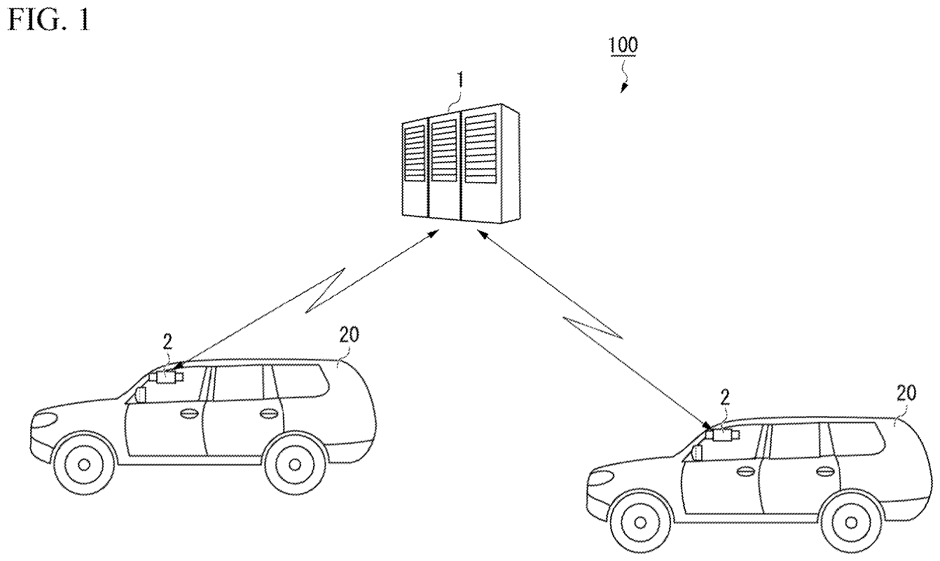

FIG. 1 is a diagram showing a travel management system 100 according to an example embodiment of the present invention.

As shown in FIG. 1, the travel management system 100 includes a travel management device 1 and a drive recorder 2 that is an aspect of a driving status sensing device. The travel management device 1 and the drive recorder 2 are connected via a wireless communication network or a wired communication network. The drive recorder 2 is provided in a vehicle 20. The travel management device 1 is communicatively connected with the drive recorder 2 installed in each of a plurality of vehicles 20 traveling in a city. In the present disclosure, the vehicle 20 is an example of a moving body.

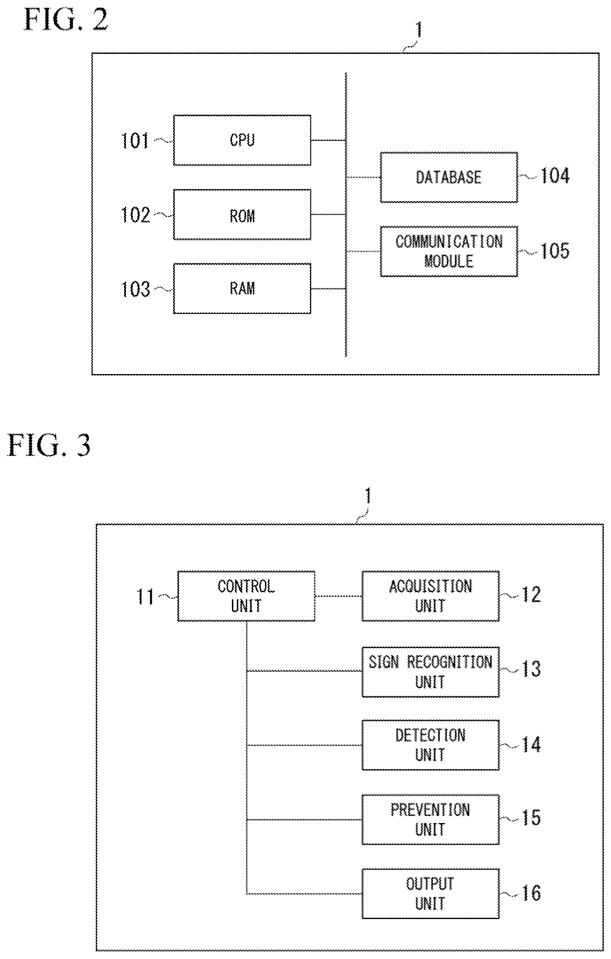

FIG. 2 is a hardware configuration diagram of the travel management device 1.

As shown in FIG. 2, the travel management device 1 is a computer including hardware such as a CPU (Central Processing Unit) 101, a ROM (Read Only Memory) 102, a RAM (Random Access Memory) 103, a database 104, and a communication module 105.

FIG. 3 is a hardware configuration diagram of the travel management device 1.

The travel management device 1 is activated when the power is turned on, and executes a travel management program stored in advance. Thereby, the travel management device 1 exhibits at least the functions of a control unit 11, an acquisition unit 12, a sign recognition unit 13, a detection unit (wrong-way travel detection unit) 14, a prevention unit (wrong-way travel prevention unit) 15, and an output unit 16.

The control unit 11 controls each function unit of the travel management device 1.

The acquisition unit 12 acquires a front captured image obtained by capturing an image to the front of the vehicle 20 and a rear captured image obtained by capturing an image to the rear of the vehicle 20.

The sign recognition unit 13 generates a front recognition result indicating the display content of a sign displayed in the front captured image and a rear recognition result indicating the display content of a sign displayed in the rear captured image.

The detection unit 14 detects that the vehicle 20 is traveling on the travel path in the direction opposite to the forward travel direction permitted on the travel path (traveling the wrong way) on the basis of at least one of the front recognition result and the rear recognition result. The detection unit 14 recognizes the forward travel direction permitted on the travel path on which the vehicle 20 is traveling (the direction that is set on the travel path and in which the vehicle 20 is permitted to travel) on the basis of at least one of the front recognition result and the rear recognition result.

The prevention unit 15 detects the possibility of the vehicle 20 traveling in the wrong direction on the travel path in the future on the basis of the front recognition result and the rear recognition result.

Upon detecting that the vehicle 20 is traveling in the wrong direction, or upon detecting the possibility of the vehicle 20 traveling in the wrong direction on the travel path in the future, the output unit 16 outputs alarm information to the drive recorder 2 provided in the vehicle 20.

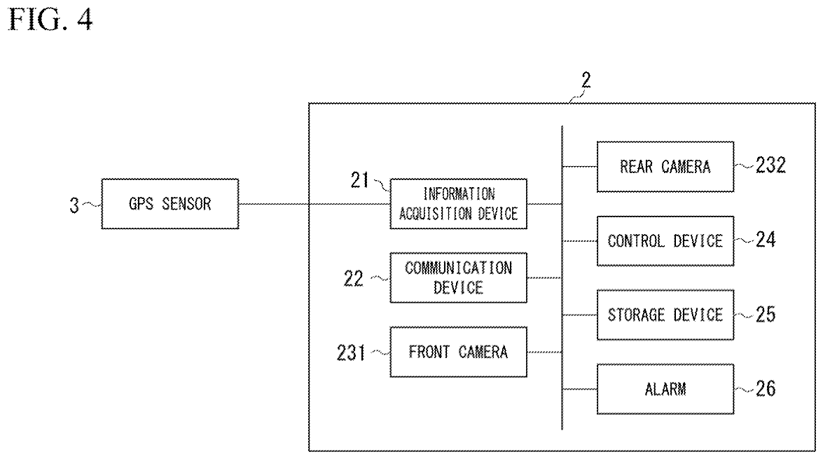

FIG. 4 is a diagram showing the hardware configuration of the drive recorder 2.

The drive recorder 2 includes at least an information acquisition device 21, a communication device 22, a front camera 231, a rear camera 232, a control device 24, a storage device 25, an alarm 26, and the like. In this disclosure, an example in which the drive recorder 2 is provided with the front camera 231 and the rear camera 232 will be described, but the present invention is not limited to such an example. For example, the front camera 231 and the rear camera 232 may be provided external to the drive recorder 2 and transmit the captured images to the drive recorder 2.

The information acquisition device 21 is connected to a GPS sensor 3 by, for example, a signal line or the like. The information acquisition device 21 acquires position information such as the current latitude and longitude of the vehicle 20 from the GPS sensor 3. The information acquisition device 21 may acquire information detected by another sensor. The information detected by these sensors is collectively referred to as sensing information.

The communication device 22 is communicably connected to the travel management device 1. The communication device 22 may be communicably connected to the travel management device 1 via a base station device or the like.

The front camera 231 generates a captured image by capturing an image to the front of the vehicle 20. It is assumed that the front camera 231 is installed at a position capable of capturing an image of a sign installed on the road of the vehicle 20. The captured image generated by the front camera 231 is referred to as a front captured image.

The rear camera 232 generates a captured image by capturing an image to the rear of the vehicle 20. It is assumed that the rear camera 232 is also installed at a position capable of capturing an image of a sign installed on the road of the vehicle 20. The captured image generated by the rear camera 232 is referred to as a rear captured image.

The control device 24 controls each function of the drive recorder 2. The control device 24 is a computer including a CPU, ROM, RAM, and the like.

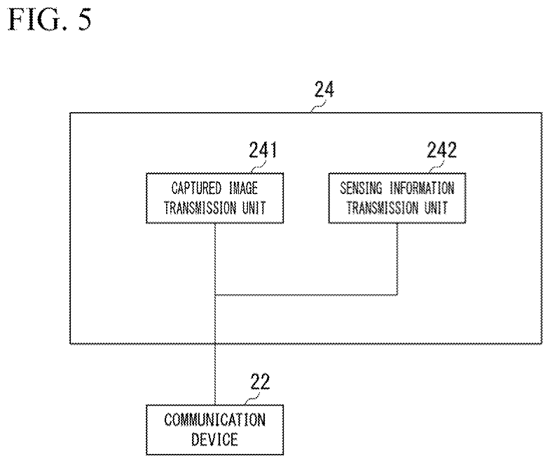

FIG. 5 is a function block diagram of the control device provided in the drive recorder 2.

The control device 24 executes a control program when the drive recorder 2 is activated. As a result, the control device 24 exhibits each function of a captured image transmission unit 241 and a sensing information transmission unit 242.

The captured image transmission unit 241 acquires the front captured image generated by the front camera 231 and the rear captured image generated by the rear camera 232 and transmits the captured images to the travel management device 1.

The sensing information transmission unit 242 acquires sensing information such as the current position information of the vehicle 20 from the information acquisition device 21 and transmits the sensing information to the travel management device 1.

The travel management device 1 according to the present disclosure generates a front recognition result indicating the display content displayed by a sign appearing in the front captured image obtained by capturing an image to the front of the vehicle 20, and a rear recognition result indicating the display content displayed by a sign appearing in the rear captured image obtained by capturing an image to the rear of the vehicle 20. The travel management device 1 detects the possibility of the vehicle 20 traveling in the wrong direction on the travel path in the future on the basis of the recognition results. Thereby, the travel management device 1 can detect the possibility of the vehicle 20 traveling in the wrong direction before the vehicle 20 is in a state of traveling in the wrong direction. Further, the travel management device 1 detects that the vehicle 20 is traveling in the wrong direction on the travel path at the position where the vehicle 20 is currently traveling, on the basis of at least one of the front captured image and the rear captured image.

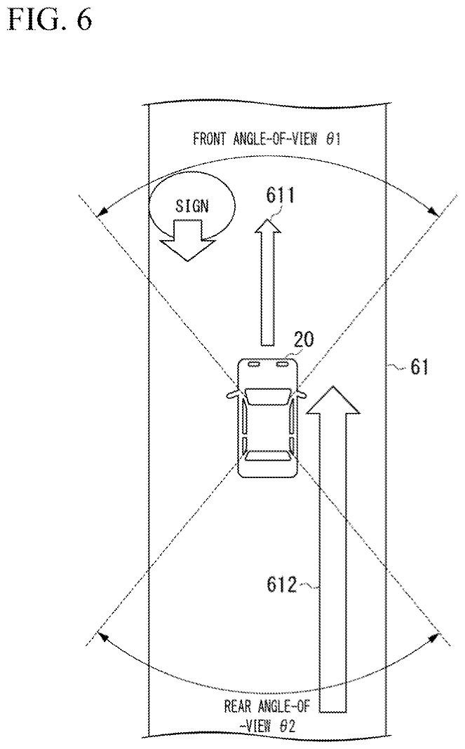

FIG. 6 is a first diagram showing the outline of processing of the travel management device 1.

It is assumed that a travel path 61 shown in FIG. 6 is one-way. When the vehicle 20 is not traveling in the wrong direction on the travel path 61, the angle formed by an advancing direction 611 of the vehicle 20 and a forward travel direction 612 of the travel path 61 is close to 0 degrees. Then, when the vehicle 20 advances on the travel path 61 in the same direction as the forward travel direction 612 and there is a sign ahead, the sign appears in the front captured image.

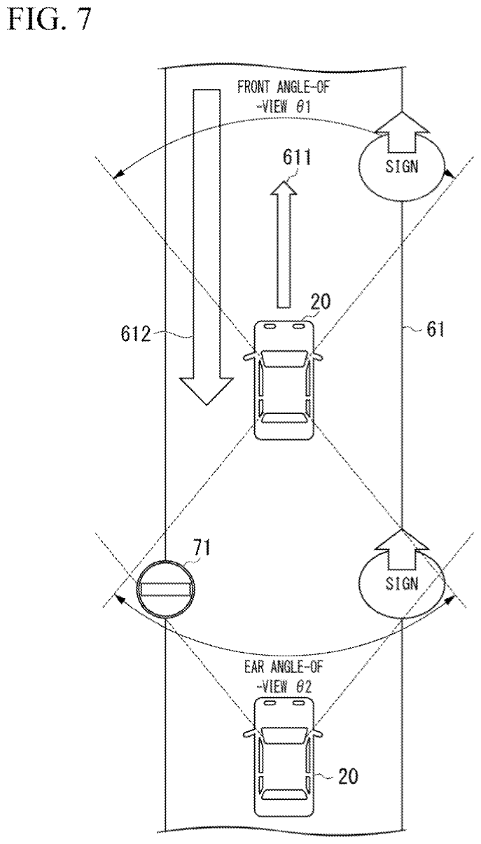

FIG. 7 is a second diagram showing the outline of processing of the travel management device 1.

When the vehicle 20 is traveling in the direction opposite to the forward travel direction 612 (traveling the wrong way) on the travel path 61, although there is a possibility of a no-entry sign appearing in the front captured image generated by the imaging of the front camera 231 of the vehicle 20, a sign directed at the vehicle 20 traveling in the forward travel direction 612 does not appear. On the other hand, a sign for the vehicle 20 heading in the forward travel direction 612 does appear in the rear captured image. When such a situation is detected, the travel management device 1 determines that the vehicle 20 is traveling in the wrong direction. Further, when there is a possibility of traveling in the wrong direction on the travel path 61, a no entry sign 71 for the vehicle 20 which may travel in the wrong direction on the travel path 61 appears in the front captured image at the time of entering the travel path 61. When such a situation is detected, the travel management device 1 determines that, although the vehicle 20 is not traveling in the wrong direction, there is a possibility of the vehicle 20 traveling in the wrong direction.

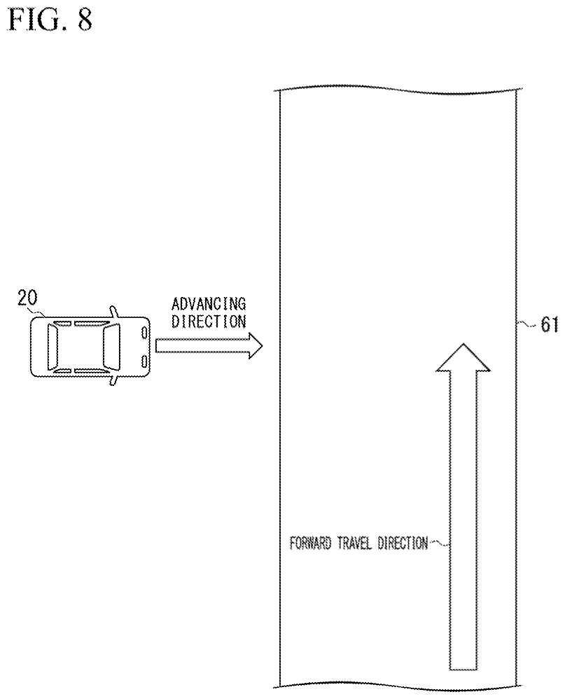

FIG. 8 is a third diagram showing an outline of processing of the travel management device 1.

A case is assumed of the vehicle 20 entering the one-way travel path 61 from the roadside of the travel path 61. For example, if there is a parking lot beside the travel path 61, or if there is another travel path leading to the travel path 61 and the vehicle 20 enters the one-way travel path 61 from that travel path, there is a possibility of the vehicle 20 accidentally traveling on the travel path 61 in the direction opposite to the forward travel direction of the travel path 61. In such a situation, the travel management device 1 determines whether the angle formed by the advancing direction of the vehicle 20 and the forward travel direction exceeds 90 degrees, and if the angle exceeds 90 degrees, determines there is a possibility of the vehicle 20 traveling in the wrong direction.

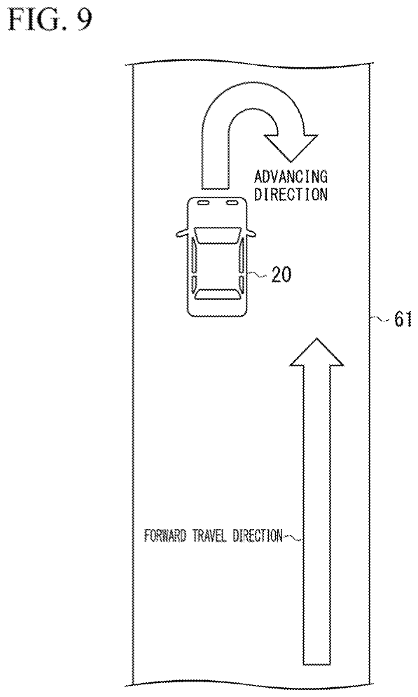

FIG. 9 is a fourth diagram showing an outline of processing of the travel management device 1.

There is a possibility of the vehicle 20 trying to turn from a state in which the vehicle 20 is traveling in the forward travel direction on the one-way travel path 61 to a state of traveling in the wrong direction. Even in such a situation, the travel management device 1 determines whether the angle formed by the advancing direction of the vehicle 20 and the forward travel direction exceeds 90 degrees, and if the angle exceeds 90 degrees, determines there is a possibility of traveling in the wrong direction.

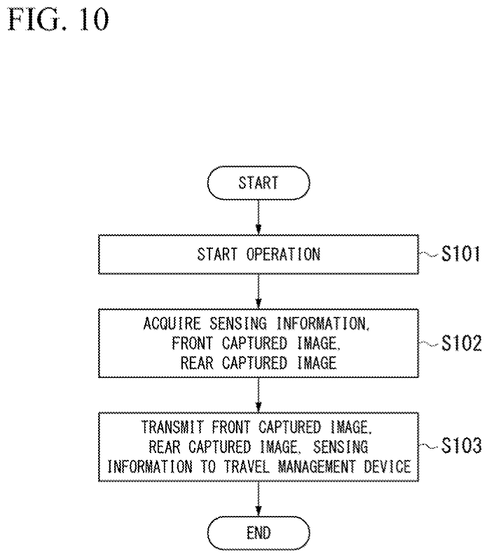

FIG. 10 is a first diagram showing the flow of processing of the drive recorder 2.

Next, the flow of processing of the drive recorder 2 will be explained step by step.

When the electrical system of the vehicle 20 is activated, the drive recorder 2 starts operation (Step S101). When the electrical system of the vehicle is activated, a sensor device such as a GPS sensor 3 starts sensing. The information acquisition device 21 acquires position information from the drive recorder 2 after the drive recorder 2 is started. The information acquisition device 21 outputs the sensing information obtained from the GPS sensor 3 and the like to the control device 24.

In the drive recorder 2, the front camera 231 generates a front captured image. In the drive recorder 2, the rear camera 232 generates a rear captured image. The front camera 231 outputs the front captured image to the control device 24. The rear camera 232 outputs the rear captured image to the control device 24. The control device 24 acquires at least the sensing information, the front captured image, and the rear captured image (Step S102). In the control device 24, the captured image transmission unit 241 requests the communication device 22 to transmit the front captured image and rear captured image that were acquired. Further, the sensing information transmission unit 242 requests the communication device 22 to transmit the acquired sensing information. The communication device 22 transmits the front captured image, the rear captured image, and the sensing information to the travel management device 1 (Step S103). The generation time of the information, the ID (identifier) of the drive recorder 2, and the like are stored in the front captured image, the rear captured image, and the sensing information.

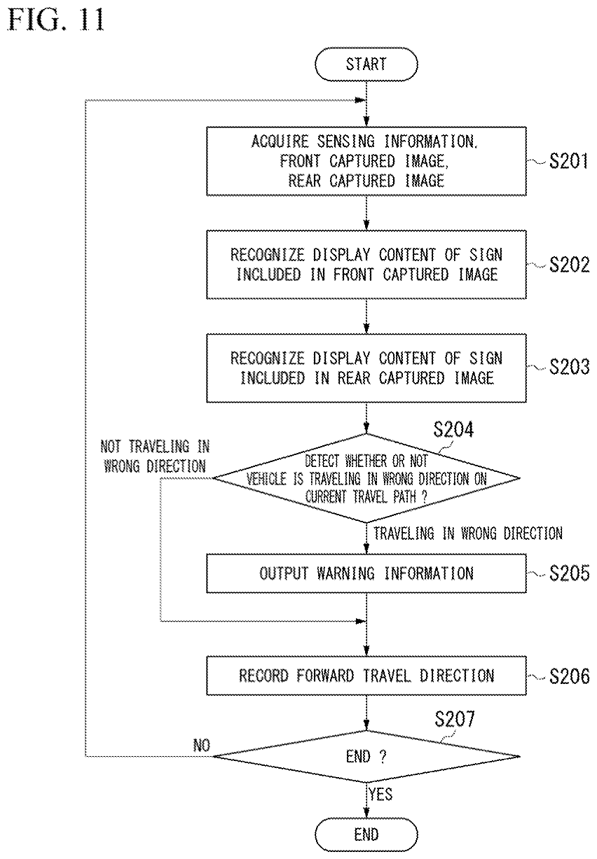

FIG. 11 is a first diagram showing the flow of processing of the travel management device 1.

In the travel management device 1, the acquisition unit 12 acquires the sensing information, the front captured image, and the rear captured image transmitted from the drive recorder 2 (Step S201). The acquisition unit 12 stores the sensing information, the front captured image, and the rear captured image in the database 104 in association with each other.

In the database 104, the sensing information, the front captured image, and the rear captured image may be recorded in association with each other based on the ID of the drive recorder 2 and the time. The acquisition unit 12 acquires the sensing information, the front captured image, and the rear captured image from the drive recorder 2 of the driving vehicle 20 at predetermined timing intervals or sequentially, and records those pieces of information in the database 104. Then, the control unit 11 instructs the sign recognition unit 13, the detection unit 14, and the prevention unit 15 to perform processing.

The sign recognition unit 13 acquires from the database 104 a new front captured image acquired from a certain drive recorder 2. The sign recognition unit 13 analyzes the front captured image to recognize the display content of a sign included in the image (Step S202). Further, the sign recognition unit 13 acquires from the database 104 a new rear captured image acquired from the drive recorder 2. The sign recognition unit 13 analyzes the rear captured image to recognize the display content of the sign included in the image (Step S203). A known technique may be used for the recognition process of the display contents of these signs. For example, in the recognition process of the display content of a sign, the front captured image and the rear captured image are input to a recognition model generated by machine learning or the like in the past, and the display content of the sign is recognized on the basis of the result output by the recognition model. The sign recognition unit 13 records the front recognition result, which is the analysis result of the front captured image and indicates the presence/absence of a sign and the display content of the sign, in the database 104 in association with the front captured image. Further, the sign recognition unit 13 records the rear recognition result, which is the analysis result of the front captured image and indicates the presence/absence of a sign and the display content of the sign, in the database 104 in association with the rear captured image. The sign recognition unit 13, upon finishing recording of the front recognition result and the rear recognition result, outputs to the detection unit 14 the ID of the drive recorder 2 that transmitted the front captured image and the rear captured image to be processed. The sign recognition unit 13 repeats the same process on each acquisition of a front captured image and a rear captured image from each drive recorder 2 of the plurality of vehicles 20.

The detection unit 14 acquires the front recognition result and the rear recognition result of the acquired ID and the position information associated therewith from the database 104. The detection unit 14 detects (determines) whether or not the vehicle 20 is traveling in the wrong direction on the current travel path corresponding to the position indicated by the acquired position information, on the basis of the presence/absence of a sign indicated by the front recognition result, the display content of the sign, the presence/absence of a sign indicated by the rear recognition result, and the display content of the sign (Step S204).

When the detection unit 14 has detected that the vehicle 20 is traveling in the wrong direction, the detection unit 14 instructs the output unit 16 to output warning information. The output unit 16 outputs warning information indicating that the vehicle 20 is traveling in the wrong direction to the drive recorder 2 (Step S205). Thereby, the drive recorder 2 acquires the alarm information and emits an alarm sound or a voice alarm. The driver can recognize that the vehicle 20 is traveling in the wrong direction. Even when the vehicle 20 is an autonomous driving vehicle, the detection unit 14 may detect that the vehicle 20 is traveling in the wrong direction.

Upon having detected that the vehicle 20 is not traveling in the wrong direction, the detection unit 14 recognizes that the current travel direction is the forward travel direction on the travel path, and records the ID of the travel path corresponding to the current position and information indicating the forward travel direction in the database 104 or the like in association with each other (Step S206). The information of the travel forward direction is used for the processing of the prevention unit 15.

Then, the detection unit 14 determines whether to end the process (Step S207), and in the case of not ending the process, stands by for input of the ID of the drive recorder 2 from the sign recognition unit 13, and upon receiving the input repeats the process from Step S201.

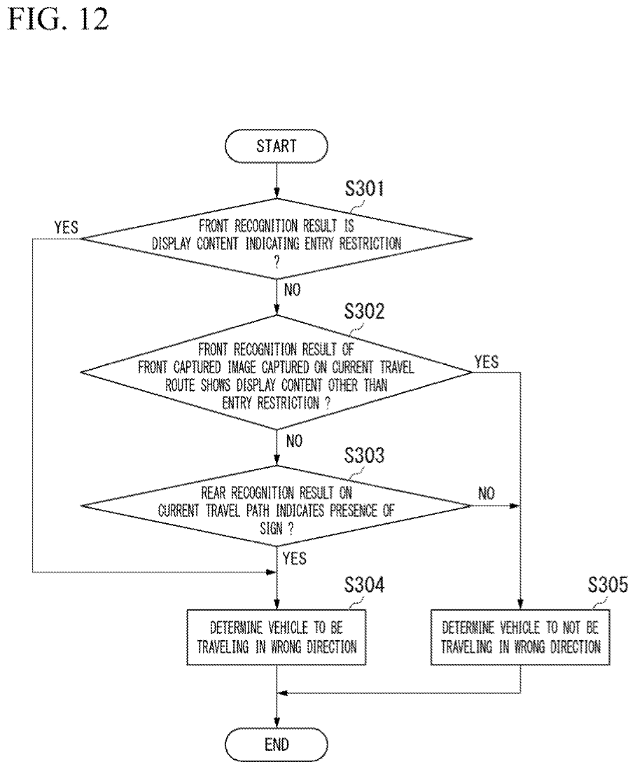

FIG. 12 is a second diagram showing the flow of processing of the travel management device 1.

The process for detecting travel in the wrong direction in Step S204 described above will be described more specifically. When the front recognition result indicates that there is a sign, the detection unit 14 reads the display content of the sign from that recognition result and determines whether the display content is display content indicating an entry restriction (for example, prohibition of vehicle entry) (Step S301). When the display content shown by the front recognition result is not display content indicating an entry restriction, the detection unit 14 acquires the current position information of the vehicle 20 based on the sensing information. The detection unit 14 determines whether or not the front recognition result shows display content other than an entry restriction in all the front captured images captured up to now on the same travel path currently being traveled that corresponds to that position information (Step S302). When the forward recognition result does not indicate display content other than an entry restriction (Step S302: No), the detection unit 14 determines whether the rear recognition result on the current travel path indicates that there is a sign (Step S303).

When the display content of a sign shown by the rear recognition result indicates a restriction such as no entry, road closed to all, or the like, the detection unit 14 determines the travel path currently being traveled to be a travel path on which travel in the opposite direction is not permitted. The ID and position information indicating the travel path and information on the forward travel direction of that travel path specified as a result of determining that travel in the opposite direction is not permitted are recorded in association with each other in the database 104. This information on the forward travel direction is used in the processing of the prevention unit 15.

Upon having determined in Step S301 that the display content of the forward recognition result is display content indicating an entry restriction, the detection unit 14 determines that the vehicle 20 is traveling in the wrong direction (Step S304). Alternatively, upon having determined that the front recognition result does not indicate display content other than an entry restriction in Step S302 and that the rear recognition result on the current travel path indicates that there is a sign in Step S303, the detection unit 14 determines that the vehicle 20 is traveling in the wrong direction (Step S304). Further, when the front recognition result indicates display content other than an entry restriction in Step S302 (Step S302: Yes), or when the rear recognition result on the current travel path indicates there is no sign in Step S303, the detection unit 14 determines that the vehicle 20 is not traveling in the wrong direction (Step S305).

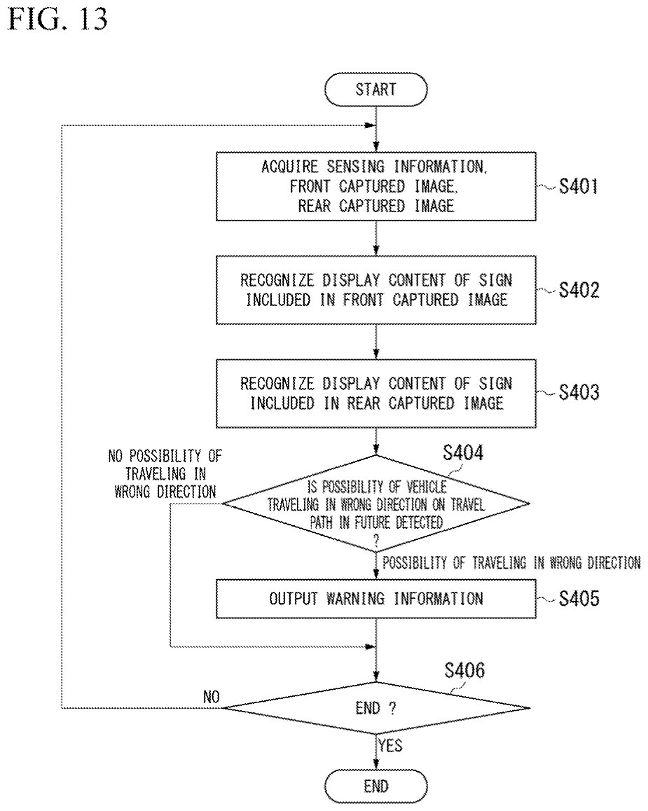

FIG. 13 is a third diagram showing the flow of processing of the travel management device 1.

The travel management device 1 performs the following processing for preventing travel in the wrong direction in parallel with the processing for detecting travel in the wrong direction described above.

In the travel management device 1, the acquisition unit 12 acquires the sensing information, the front captured image, and the rear captured image transmitted from the drive recorder 2 (Step S401). The acquisition unit 12 stores the sensing information, the front captured image, and the rear captured image in the database 104 in association with each other.

In the database 104, the sensing information, the front captured image, and the rear captured image may be recorded in association with each other based on the ID of the drive recorder 2 and the time. The acquisition unit 12 acquires the sensing information, the front captured image, and the rear captured image from the drive recorder 2 of the driving vehicle 20 at predetermined timing intervals or sequentially, and records those pieces of information in the database 104. Then, the control unit 11 instructs the sign recognition unit 13, the detection unit 14, and the prevention unit 15 to perform processing.

The sign recognition unit 13 acquires from the database 104 a new front captured image acquired from a certain drive recorder 2. The sign recognition unit 13 analyzes the front captured image to recognize the display content of the sign included in the image (Step S402). Further, the sign recognition unit 13 acquires from the database 104 a new rear captured image acquired from the drive recorder 2. The sign recognition unit 13 analyzes the rear captured image to recognize the display content of the sign included in the image (Step S403). The sign recognition unit 13 records the front recognition result, which is the analysis result of the front captured image and shows the presence/absence of a sign and the display content of the sign, in the database 104 in association with the front captured image. Further, the sign recognition unit 13 records the rear recognition result, which is the analysis result of the front captured image and shows the presence/absence of a sign and the display content of the sign, in the database 104 in association with the rear captured image. The sign recognition unit 13, upon finishing recording of the front recognition result and the rear recognition result, outputs the ID of the drive recorder 2 that transmitted the front captured image and the rear captured image to be processed to the prevention unit 15. Since the processes of steps S401 to S403 are the same as the processes of the detection unit 14, they may be common processes.

The prevention unit 15 acquires the front recognition result, the rear recognition result, and the position information recorded in the database 104 in association with the ID acquired from the sign recognition unit 13. The prevention unit 15 also acquires from the database 104 the forward travel direction of the travel path currently being traveled or a travel path in the vicinity of the current position. Then, the prevention unit 15 detects whether or not there is a possibility of traveling in the wrong direction on the travel path in the future on the basis of the presence/absence of a sign and the display content of the sign that are indicated by the front recognition result, the presence/absence of a sign and the display content of the sign that are indicated by the rear recognition result, and the forward travel direction of the travel path currently being traveled or a travel path in the vicinity of the present position (Step S404).

Upon having detected that there is a possibility of traveling in the wrong direction, the prevention unit 15 instructs the output unit 16 to output warning information. The output unit 16 outputs warning information to the drive recorder 2 indicating there is a possibility of traveling in the wrong direction. As a result, the drive recorder 2 acquires the alarm information and emits an alarm sound or a voice alarm. The driver is able to recognize that there is a possibility of traveling in the wrong direction. Even when the vehicle 20 is an autonomous driving vehicle, the prevention unit 15 may detect there is a possibility of traveling in the wrong direction.

In the case of having detected that there is no possibility of traveling in the wrong direction, or in the case of having output the warning information in Step S405, the prevention unit 15 determines whether to end the process (Step S406). In the case of not ending the process, the prevention unit 15 stands by for input of the ID of the drive recorder 2, and upon receiving the input repeats the process from Step S401.

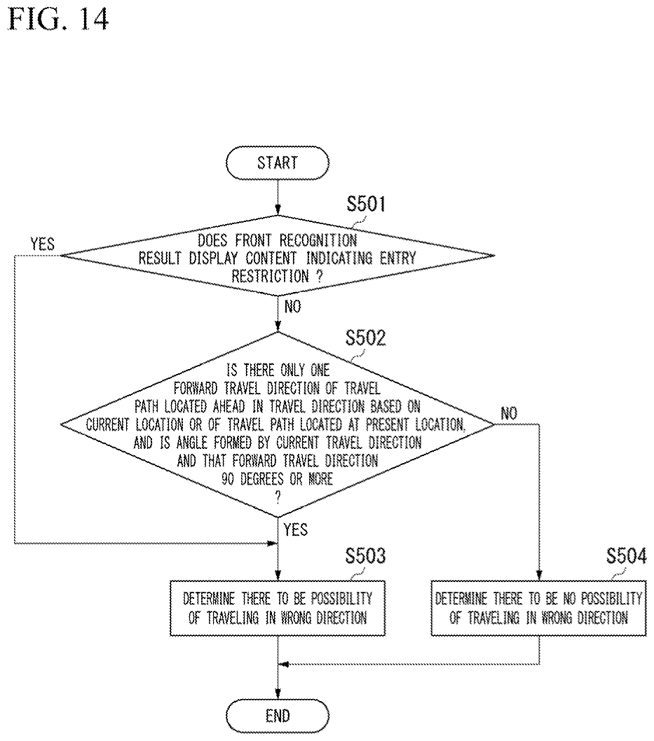

FIG. 14 is a fourth diagram showing the flow of processing of the travel management device 1.

The process for preventing travel in the wrong direction in Step S404 described above will be described more specifically. When the front recognition result indicates that there is a sign, the prevention unit 15 reads the display content of the sign from that recognition result and determines whether the display content is display content indicating an entry restriction (Step S501). When the display content shown by the front recognition result is not display content indicating an entry restriction, the prevention unit 15 acquires the current position information of the vehicle 20 based on the sensing information. The prevention unit 15 detects the travel direction at the current position. Further, the prevention unit 15 acquires from the database 104 information on the forward travel direction of the travel path located ahead in the travel direction, on the basis of the current position information and the travel direction. The prevention unit 15 compares the current travel direction with the acquired forward travel direction of the travel path, and determines whether only one forward travel direction is recorded in the database 104 for the travel path located ahead or the travel path currently being traveled, and whether the angle formed by the vector between the current travel direction and that forward travel direction is 90 degrees or more (Step S502).

In the process of Step S502, for example, in the case of returning to a travel path from a parking lot in the vicinity of that travel path, on which only one-way traffic is permitted, when the angle between the advancing direction of the vehicle and the forward travel direction of the travel path is 90 degrees or more, it is determined that there is a possibility of the vehicle traveling the wrong direction in the one-way traffic. For example, in the case of returning from the service area of an expressway to the main expressway, when the angle between the forward travel direction of the travel path leading to the main expressway and the current advancing direction of the vehicle is 90 degrees or more, it is determined that there is a possibility of the vehicle traveling in the wrong direction on the one-way travel path from the main expressway to the service area.

Upon having determined in Step S501 that the display content of the front recognition result is display content indicating an entry restriction, the prevention unit 15 determines that there is a possibility of traveling in the wrong direction (Step S503).

Alternatively, when only one forward travel direction is recorded in the database 104 for the travel path located ahead or the travel path currently being traveled, and the angle formed by the vector between the current travel direction and the forward travel direction is 90 degrees or more in Step S502, the prevention unit 15 determines there is a possibility of the vehicle traveling in the wrong direction (Step S503). If NO in Step S502, the prevention unit 15 determines there is no possibility of the vehicle traveling in the wrong direction (Step S504).

The travel management device 1 of the present disclosure has been described above. According to the above processing, the travel management device 1 can detect the state in which the vehicle 20 is traveling in the wrong direction or the possibility of the vehicle 20 (moving body) traveling in the wrong direction before the vehicle 20 travels in the wrong direction. According to the processing of the travel management device 1 of the present disclosure, since detection of travel in the wrong direction and detection of the possibility of travel in the wrong direction are performed by utilizing the information of signs, it is possible to perform those detections over the entire road area where a sign would exist. That is, the detectable area can be widened. According to the above-mentioned processing of the travel management device 1, since information of road signs at the time of traveling of the moving body is utilized, it is possible to prevent erroneous detection of travel in the wrong direction or the possibility of travel in the wrong direction due to out-of-date map information.

In the above process, the sign recognition unit 13 may recognize a sign installed on the roadside or may recognize a sign printed on the road. The sign recognition processing unit 13 may perform recognition of the presence/absence of a sign and recognition of the display content on the basis of the pixel information of only a predetermined area where a sign is likely to appear in the front captured image and the rear captured image. The sign recognition unit 13 may determine the position of the predetermined area where the sign appears based on the detection of a guardrail, a travel line on the road surface, or the like. Further, the travel management device 1 may specify position information indicating a position at which it is detected that the vehicle 20 is traveling in the wrong direction and position information indicating a position at which the possibility of the vehicle 20 traveling in the wrong direction is detected, and statistically process the positions where it is detected that the vehicle travels in the wrong direction or where there is a high possibility of traveling in the wrong direction. This statistically processed information may be used for city planning and the like.

The travel management device 1 may store information of the result of detecting that the vehicle 20 is traveling in the wrong direction and the result of detecting the possibility that the vehicle 20 is traveling in the wrong direction, which are generated by the above processing, for use in driving tendency analysis of the driver who drives the vehicle 20. Further, the travel management device 1 may use information of the result of detecting that the vehicle 20 is traveling in the wrong direction and the result of detecting the possibility that the vehicle 20 is traveling in the wrong direction for output as driving history information.

The above-mentioned process is a process assuming a case where the travel management device 1 and the drive recorder 2 are communicably connected and the travel management device 1 is configured as a server device connected to a communication network. However, the function of the travel management device 1 may be provided in an in-vehicle device such as a drive recorder 2. Hereinbelow, processing when the drive recorder 2 is provided with the function of the travel management device 1 will be described.

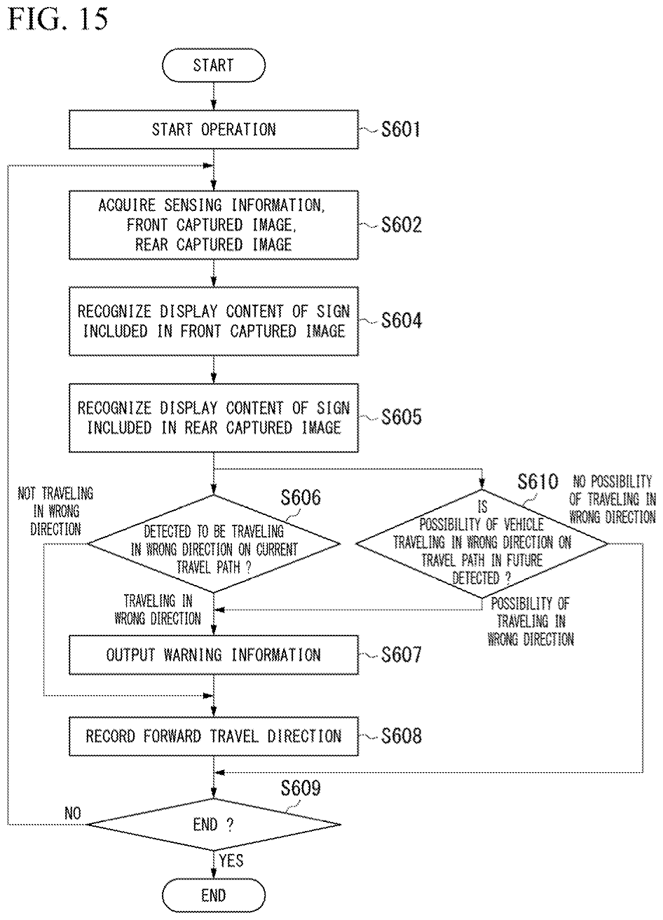

FIG. 15 is a second diagram showing the flow of processing of the drive recorder 2.

When the electric system of the vehicle 20 is activated, the drive recorder 2 starts operation (Step S601). When the electrical system of the vehicle is activated, a sensor device such as a GPS sensor 3 starts sensing. The information acquisition device 21 acquires position information from the drive recorder 2 after the drive recorder 2 is started. The information acquisition device 21 outputs the sensing information such as GPS information to the control device 24.

In the drive recorder 2, the front camera 231 generates a front captured image. In the drive recorder 2, the rear camera 232 generates a rear captured image. The front camera 231 outputs the front captured image to the control device 24. The rear camera 232 outputs the rear captured image to the control device 24. The control device 24 acquires at least the sensing information, the front captured image, and the rear captured image (Step S602). The control device 24 performs a process corresponding to the above-mentioned travel management device 1. That is, the control device 24 exhibits the function of each processing unit shown in FIG. 3. Hereinbelow, a case where the control device 24 includes the travel management device 1 will be described.

The acquisition unit 12 of the travel management device 1 acquires sensing information, a front captured image, and a rear captured image from the control device 24. The acquisition unit 12 stores the sensing information, the front captured image, and the rear captured image in the storage device 25 in association with each other. In the storage device 25, the sensing information, the front captured image, and the rear captured image may be recorded in association with each other based on the ID of the drive recorder 2 and the time. The acquisition unit 12 sequentially acquires the sensing information, the front captured image, and the rear captured image, and records those pieces of information in the storage device 25. Then, the control unit 11 instructs the sign recognition unit 13, the detection unit 14, and the prevention unit 15 to perform processing.

The sign recognition unit 13 acquires from the storage device 25 a new front captured image that was acquired. The sign recognition unit 13 analyzes the front captured image to recognize the display content of a sign included in the image (Step S604). Further, the sign recognition unit 13 acquires from the storage device 25 a new rear captured image that was acquired. The sign recognition unit 13 analyzes the rear captured image to recognize the display content of a sign included in the image (Step S605). The sign recognition unit 13 records the front recognition result, which is the analysis result of the front captured image and indicates the presence/absence of a sign and the display content of the sign, in the storage device 25 in association with the front captured image. Further, the sign recognition unit 13 records the rear recognition result, which is the analysis result of the front captured image and indicates the presence/absence of a sign and the display content of the sign, in the storage device 25 in association with the rear captured image. The sign recognition unit 13, upon finishing recording of the front recognition result and the rear recognition result, instructs the detection unit 14 to perform processing. The sign recognition unit 13 repeats the same process on each acquisition of a front captured image and a rear captured image.

The detection unit 14 acquires a new front recognition result, a rear recognition result, and position information associated therewith from the storage device 25. The detection unit 14 detects whether or not the vehicle is traveling in the wrong direction on the current travel path corresponding to the position indicated by the acquired position information, on the basis of the presence/absence of a sign and the display content of the sign that are indicated by the front recognition result, and the presence/absence of a sign and the display content of the sign that are indicated by the rear recognition result (Step S606).

When the detection unit 14 has detected that the vehicle 20 is traveling in the wrong direction, the detection unit 14 instructs the output unit 16 to output warning information. The output unit 16 outputs alarm information to the alarm 26 (Step S607). Thereby, the alarm 26 emits an alarm sound or a voice alarm. The driver can recognize that the vehicle 20 is traveling in the wrong direction.

Upon having detected that the vehicle 20 is not traveling in the wrong direction, the detection unit 14 recognizes that the current travel direction is the forward travel direction on the travel path, and records the ID of the travel path corresponding to the current position and information indicating the forward travel direction in the storage device 25 in association with each other (Step S608). The information of the forward travel direction is used for the processing of the prevention unit 15. The detection unit 14 determines whether to end the process (Step S609), and in the case of not ending the process, stands by for a process instruction from the sign recognition unit 13, and upon receiving input of the process instruction, repeats the same process from the Step S603. The details of the process for detecting travel in the wrong direction are the same as the process described with reference to FIG. 12 described above.

The prevention unit 15 acquires the front recognition result, the rear recognition result, and the position information recorded in the storage device 25 in association with the ID acquired from the sign recognition unit 13. The prevention unit 15 also acquires from the storage device 25 the forward travel direction of the travel path currently being traveled or a travel path in the vicinity of the current position. Then, the prevention unit 15 detects whether or not there is a possibility of traveling in the wrong direction on the travel path in the future on the basis of the presence/absence of a sign and the display content of the sign that are indicated by the front recognition result, the presence/absence of a sign indicated by the rear recognition result and the display content of the sign that are indicated by the front recognition result, and the forward travel direction of the travel path currently being traveled or a travel path in the vicinity of the present position (Step S610).

Upon having detected that there is a possibility of traveling in the wrong direction, the prevention unit 15 instructs the output unit 16 to output warning information by the process of Step S607. The output unit 16 outputs alarm information to the alarm 26 indicating there is a possibility of traveling in the wrong direction. As a result, the alarm 26 acquires the alarm information and emits an alarm sound or a voice alarm. The driver is able to recognize that there is a possibility of traveling in the wrong direction.

In the case of having detected that there is no possibility of traveling in the wrong direction, the prevention unit 15 determines whether to end by the process of Step S609. The prevention unit 15, in the case of not ending the process, repeats the process from Step S603. The details of the process for preventing travel in the wrong direction are the same as the process described with reference to FIG. 14 described above.

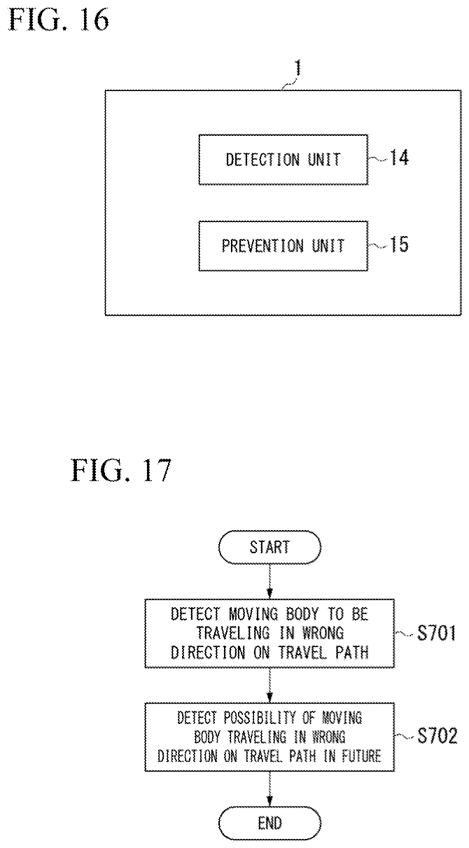

FIG. 16 is a diagram showing an example of the configuration of the travel management device 1.

FIG. 17 is a diagram showing the flow of processing by the travel management device 1 shown in FIG. 16.

It is sufficient that that the travel management device 1 include at least a detection unit 14 and a prevention unit 15.

The detection unit 14 detects that a moving body is traveling in the wrong direction on a travel path on the basis of at least one of a front recognition result indicating the display content displayed by a sign appearing in a captured image obtained by capturing an image to the front of the moving body, and a rear recognition result indicating the display content displayed by a sign appearing in a rear captured image obtained by capturing an image to the rear of the moving body (Step S701).

The prevention unit 15 detects the possibility that the moving body will travel in the wrong direction on the travel path in the future on the basis of the front recognition result and the rear recognition result (Step S701).

The above-mentioned travel management device 1 and drive recorder 2 have a computer system inside. The process of each process described above is stored in a computer-readable recording medium in the form of a program, with the process being performed by the computer reading and executing this program. Here, the computer-readable recording medium refers to a magnetic disk, a magneto-optical disk, a CD-ROM, a DVD-ROM, a semiconductor memory, or the like. Further, this computer program may be distributed to a computer via a communication line, and the computer receiving the distribution may execute the program.

The aforementioned program may be one for realizing some of the functions described above.

Further, a so-called differential file (differential program) may be used, which can realize the above-mentioned functions in combination with a program already recorded in the computer system.

This application is based upon and claims the benefit of priority from Japanese patent application No. 2019-108134, filed Jun. 10, 2019, the disclosure of which is incorporated herein in its entirety by reference.

### INDUSTRIAL APPLICABILITY

The present invention may be applied to a travel management device, a travel management method, and a recording medium.

### REFERENCE SYMBOLS

1: Travel management device

2: Drive recorder

3: GPS sensor

11: Control unit (control means)

12: Acquisition unit (acquisition means)

13: Sign recognition unit (sign recognition means)

14: Detection unit (wrong-way travel detection unit, detection means)

15: Prevention unit (wrong-way travel prevention unit, prevention means)

16: Output unit (output means)

21: Information acquisition device

22: Communication device

231: Front camera

232: Rear camera

24: Control device

241: Captured image transmission unit (captured image transmission means)

242: Sensing information transmission unit (sensing information transmission means)

What is claimed is:

1. A travel management device comprising:
at least one memory configured to store instructions; and
at least one processor configured to execute the instructions to:
detect that a moving body is traveling in a wrong direction on a travel path on which the moving body is currently traveling, based on at least one of a front recognition result and a rear recognition result, the front recognition result indicating display content displayed by a sign appearing in a front captured image, the front captured image being obtained by capturing an image to front of the moving body, the rear recognition result indicating display content displayed by a sign appearing in a rear captured image, the rear captured image being obtained by capturing an image to rear of the moving body; and
detect a possibility of the moving body traveling in a wrong direction in future on a travel path located ahead in a travel direction of the moving body than the travel path on which the moving body is currently traveling, based on at least one of the front recognition result and the rear recognition result.

2. The travel management device according to claim 1, wherein the at least one processor is configured to execute the instructions to recognize a forward travel direction permitted on the travel path on which the moving body is currently traveling, based on at least one of the front recognition result and the rear recognition result.

3. The travel management device according to claim 2, wherein the at least one processor is configured to execute the instructions to detect the possibility of the moving body traveling in the wrong direction in the future on the travel path located ahead, based on a travel direction of the moving body at a current position thereof and information of a forward travel direction permitted for the travel path located ahead.

4. The travel management device according to claim 2, wherein the at least one processor is configured to execute the instructions to detect that the moving body is traveling in the wrong direction on the travel path on which the moving body is currently traveling, based on a comparison of information of the forward travel direction of the travel path on which the moving body is currently traveling and a travel direction of the moving body at a current position thereof.

5. The travel management device according to claim 1, wherein the at least one processor is configured to execute the instructions to detect that the moving body is traveling in the wrong direction on the travel path on which the moving body is currently traveling when a sign showing display content other than an entry restriction is not detected from the front recognition result of the front captured image captured in the travel path on which the moving body is currently traveling, and a sign showing display content notifying a moving body traveling in a forward travel direction permitted for the travel path on which the moving body is currently traveling is detected from the rear recognition result of the rear captured image captured in the travel path on which the moving body is currently traveling.

6. A travel management method comprising:
detecting that a moving body is traveling in a wrong direction on a travel path on which the moving body is currently traveling, based on at least one of a front recognition result and a rear recognition result, the front recognition result indicating display content displayed by a sign appearing in a front captured image, the front captured image being obtained by capturing an image to front of the moving body, the rear recognition result indicating display content displayed by a sign appearing in a rear captured image, the rear captured image being obtained by capturing an image to rear of the moving body; and
detecting a possibility of the moving body traveling in a wrong direction in future on a travel path located ahead in a travel direction of the moving body than the travel path on which the moving body is currently traveling, based on at least one of the front recognition result and the rear recognition result.

7. A non-transitory recording medium storing a program for causing a computer of a travel management device to execute:
detecting that a moving body is traveling in a wrong direction on a travel path on which the moving body is currently traveling, based on at least one of a front recognition result and a rear recognition result, the front recognition result indicating display content displayed by a sign appearing in a front captured image, the front captured image being obtained by capturing an image to front of the moving body, the rear recognition result indicating display content displayed by a sign appearing in a rear captured image, the rear captured image being obtained by capturing an image to rear of the moving body; and
detecting a possibility of the moving body traveling in a wrong direction in future on a travel path located ahead in a travel direction of the moving body than the travel path on which the moving body is currently traveling, based on at least one of the front recognition result and the rear recognition result.
